(19) United States
(12) Patent Application Publication
(10) Pub. No.: US 2012/0099847 A1
(43) Pub. Date: Apr. 26, 2012

(54) Systems and Methods For Controlling A Photographic Modeling Light Using One or More Camera Body Control Signals

(75) Inventor: James E. Clark, South Burlington, VT (US)

(73) Assignee: LAB PARTNERS ASSOCIATES, INC., South Burlington, VT (US)

(21) Appl. No.: 13/201,182

(22) PCT Filed: Feb. 12, 2010
(86) PCT No.: PCT/US10/24108

§ 371 Date: Dec. 13, 2011

Related U.S. Application Data
(60) Provisional application No. 61/151,872, filed on Feb. 12, 2009.

(51) Int. Cl. G03B 15/05

(52) U.S. Cl. 396/182

(57) ABSTRACT

A control system for controlling illumination output of photographic modeling lighting in response to camera body signaling/user control actuation. The control system is configured to detect one or more camera body signals. The control system generates an illumination output control signal in response to the detected camera body signal(s). The control system then transmits the illumination output control signal to one or more modeling lighting devices so as to cause the device(s) to operate at a first illumination output level. The control system also causes the modeling lighting device(s) to change from the first illumination level to a second illumination level. In one example, the second change occurs as a function of a preset delay. In another example, the second change occurs in response to a user actuating one or more camera body controls.

### RELATED APPLICATION DATA

This application claims the benefit of priority of U.S. Provisional Patent Application No. 61/151,872, filed on Feb. 12, 2009, and titled “Systems And Methods For Controlling A Photographic Modeling Light Using One Or More Camera Body Control Signals,” which is incorporated herein by reference in its entirety.

### FIELD OF THE INVENTION

The present invention generally relates to the field of photographic lighting. In particular, the present invention is directed to systems and methods for controlling a photographic modeling light using one or more camera body control signals.

### BACKGROUND

Many situations in photography require precise control of lighting that illuminates a photographic subject/scene. For example, in flash photography it is often necessary to position and orient one or more flash-lighting sources at locations that minimize unwanted shadows, reflection, glare, etc. caused by the flash-lighting and/or create a desired shadow pattern (or other lighting effect) in the captured image. It is also desirable to provide ample lighting that allows a photographer to assess, prior to image acquisition, the subject in light that reasonably approximates the illumination effect that will result in the acquired image. However, flash-lighting is generally so short in duration that any pre-image-acquisition firing of the flash-lighting source(s) does not provide the photographer ample time to assess the effects the flash-lighting will have in the captured image. Consequently, it is common practice in some photographic settings for a photographer to use a modeling light to approximate the effects the image-acquisition flash lighting will have on the acquired image.

Generally, there are two types of modeling light sources, non-flash-based sources and flash-based sources. A non-flash-based modeling light source typically uses one or more relatively high power continuous-lighting lamps, such as a tungsten lamp having a power from 100 W to 750 W or more. A non-flash-based modeling light source can be integrated into a common unit with an image-acquisition flash-lighting source, such as xenon flash lamp. Typically, a photographer, photographer's assistant, etc. turns a non-flash-based modeling light source on and off either at the source or remotely using a dedicated remote control device designed for that purpose. When on, non-flash-based modeling light sources radiate large amounts of heat due to the relatively high power of the continuous-lighting lamp(s). This high heat can be problematic for both live models and still life subjects.

A flash-based modeling light source is a lighting source that does not include any continuous-lighting lamps, but rather utilizes a flash-lighting source, for example, one or more xenon flash lamps, to provide a series of flashes of sufficient intensity and duration that allow a photographer to assess the effects that the image-acquisition flash lighting will have on the captured image. To provide this functionality, flash-based modeling light sources typically have special circuitry that pulses the flash-lighting source over a period of time sufficient to allow the photographer to make an assessment. In one conventional flash-based modeling light example, a portrait mode modeling light is provided by strobing the flash light at a frequency of 10 Hz for 1.5 seconds. In that same example, a macro mode modeling light is provided by strobing the flash light at a frequency of 40 Hz for 4 seconds. A flash-based modeling light source is typically integrated into an image-acquisition flash-lighting device by providing that device with the one or more modeling-light modes in addition to the image-acquisition flash-lighting mode. A photographer typically causes such image-acquisition flash lighting device to enter the modeling-light mode by pressing a modeling-light button on the device. In some cases, it is desirable to minimize the use of flash-based modeling lighting because the rapid flashing of the image-acquisition flash-lighting device can be bothersome to live models.

### SUMMARY OF THE DISCLOSURE

In one implementation, the present disclosure is directed to a method of controlling illumination output of a modeling lighting device located remote from a camera body. The method includes: detecting at least one camera body signal; generating a first illumination output change signal in response to the detecting of the at least one camera body signal, wherein the first illumination output change signal is configured to change the illumination output of the modeling lighting device; and transmitting the first illumination output change signal to the modeling lighting device so as to cause the modeling lighting device to operate at a first illumination output level.

In another implementation, the present disclosure is directed to a machine-readable storage medium containing machine-executable instructions for controlling illumination output of a modeling lighting device located remote from a camera body. The machine-executable instructions include: a first set of machine-executable instructions for implementing detection of an indication of at least one camera body signal; a second set of machine-executable instructions for generating a first illumination output change signal in response to the detecting of the indication of the at least one camera body signal, wherein the first illumination output change signal is configured to change the illumination output of the modeling lighting device; and a third set of machine-executable instructions for controlling transmission of the first illumination output change signal to the modeling lighting device so as to cause the modeling lighting device to operate at a first illumination output level.

In still another implementation, the present disclosure is directed to a system. The system includes: a modeling lighting control system configured to control illumination output of a modeling lighting device in response to at least one camera body signal of a camera body, the modeling lighting control system including: first means for detecting the at least one camera body signal; second means for generating a first illumination output change signal in response to the detecting of the at least one camera body signal, wherein the first illumination output change signal is configured to change the illumination output of the modeling lighting device; third means for transmitting the first illumination output change signal to the modeling lighting device so as to cause the modeling lighting device to operate at a first illumination output level; and fourth means for causing the modeling lighting device to change from the first illumination output level to a second illumination output level different from the first illumination output level.

In yet another implementation, the present disclosure is directed to a method of controlling illumination output of a modeling lighting device located remote from a first camera body. The method includes: detecting at least one camera body signal from the first camera body; generating a first illumination output change signal in response to the detecting of the at least one camera body signal, wherein the first illumination output change signal is configured to change the illumination output of the modeling lighting device to a first output; transmitting the first illumination output change signal to the modeling lighting device so as to cause the modeling lighting device to operate at a first illumination output level; starting a delay timer that delays transmitting of a second illumination output change signal configured to change the illumination output of the modeling lighting device from the first output to a second output different from the first output; restarting the delay timer in response to detecting a wireless signal indicating that a second camera body is still awake; and when the delay timer times out, transmitting the second illumination output change signal.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating a method of controlling the scene illumination output of one or more modeling lights using a camera body;

FIG. 2 is a diagram of a photographic system that includes a camera, a wireless controller, a remote multifunctional lighting system incorporating a modeling lighting source, and a remote standalone modeling lighting device, wherein the system is configured to perform steps of the method of FIG. 1;

FIG. 3 is a high-level diagram of the wireless controller of FIG. 2;

FIG. 4 is a diagram illustrating a computer-based environment for configuring a wireless controller, such as the wireless controller of FIGS. 2 and 3;

FIGS. 5A-B together contain a flow diagram illustrating a method of controlling the scene illumination output of modeling lighting using a controller having a wake mode, an autofocus assist mode and a backlight mode, such as the controller of FIGS. 2 and 3;

FIG. 6 is an example timing diagram illustrating functioning of the autofocus assist mode of a controller, such as the controller of FIGS. 2 and 3, using the control settings illustrated on the screen of the graphical user interface of FIG. 4;

FIG. 7 is an example timing diagram illustrating functioning of the wakeup mode of a controller, such as the controller of FIGS. 2 and 3, using the control settings illustrated on the screen of the graphical user interface of FIG. 4;

FIG. 8 is a diagram illustrating circuitry and corresponding signaling suitable for use in the camera body interface of a controller, such as the controller of FIGS. 2 and 3;

FIG. 9 is a flow diagram illustrating another method of using a camera body to control illumination output of modeling lighting;

FIG. 10 is an example timing diagram illustrating the control of one or more modeling lighting devices to implement pupil-dilation functionality;

FIG. 11 is a diagram illustrating a digital camera-body-status communication signal containing autofocus assist and backlight information that a controller of the present disclosure can use to control one or more modeling lighting device(s); and

FIG. 12 is high-level block diagram illustrating a wireless remote modeling lighting device controller and the flexibility in locating parts internally and externally relative to a camera body.

### DETAILED DESCRIPTION

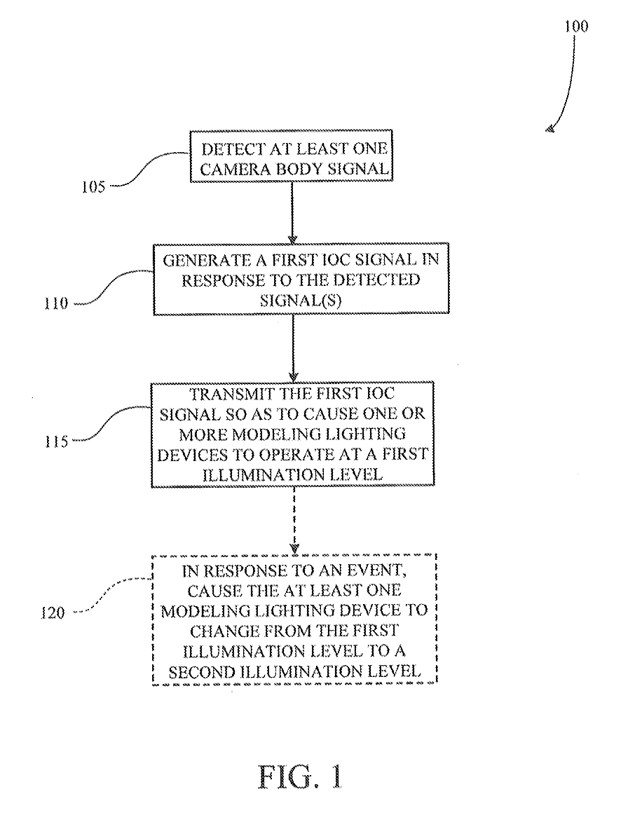

Referring now to the drawings, FIG. 1 illustrates a method 100 of controlling the scene illumination output level of one or more modeling light devices based on one or more camera body signals. As will be readily understood by those skilled in the art after reading this entire disclosure, a control method containing broad concepts disclosed herein, such as method 100, is useful for a number of purposes, including allowing a photographer to use modeling lighting to check for unwanted and/or wanted lighting effects and levels that will appear in images captured using flash photography without having to remove an eye from the camera's viewfinder or live-view display and using modeling lighting to provide light for assisting a camera in carrying out its autofocus functionality.

Method 100 typically begins at step 105 by detecting one or more camera body signals. As used herein and in the appended claims, the term “camera body signal” means a signal generated either internally or externally relative to the camera body and that is used to control functionality inherent in the camera body itself, any lens attached thereto and any image-acquisition flash-lighting device attached to the camera body or responsive to a flash-sync signal generated by the camera body. Because modeling lighting in the context of the present disclosure is used prior to any image capturing, a shutter-release signal is excluded from the term “camera body signal.” As those skilled in the art will appreciate, the term “shutter” as used herein and in the appended claims is intended to refer to a mechanical shutter, an electronic shutter and any combination thereof and equivalent thereto.

A camera body signal can be generated by a user actuating any type of switch or other actuator, mechanical, soft or otherwise. A camera body signal can also be generated by circuitry internal to a camera body in response to any one or more of a variety of events, such as a user actuating a switch (e.g., a partial press (a/k/a “half press”) of a shutter release button or a press of an autofocus button or a depth-of-field preview button) and camera body circuitry determining a particular function is needed (e.g., a camera processor determining that the lens needs to be autofocused), among others. Examples of a camera body signal generated internally within the camera body include, but are not limited to, a camera body wake signal, a camera body sleep signal, an autofocus assist signal, a camera body backlighting on/off signal, a menu control signal, a flash compensation signal, a signal from a “click wheel” or other user control, such as a partial-press switch signal generated upon a partial press of a shutter-release button. Examples of a camera body signal generated externally include, but are not limited to, a partial-press switch signal initiated from an external device and communicated to the camera body, for example, via an external communications port on the camera body (e.g., a hotshoe, a proprietary connector port, a motor-drive port, a universal serial bus (USB) port, a “FIREWIRE” (IEEE 1394) port, etc.) and any other camera body signal that can be initiated or generated externally from the camera body. Specific examples are described below in detail to give the reader an understanding of how step 105 can be implemented.

However, those skilled in the art will appreciate that controls provided to a particular camera body and camera body control signals vary to a great extent such that it is impractical to cover all current conventional camera body controls and camera body control signals, and that it is virtually impossible to predict future camera body controls and camera body control signals. That said, those skilled in the art will readily be able to implement the broad concepts of the present disclosure for virtually any one or more camera body controls and/or any one or more camera body signals. The detection of the one or more camera body signals can be performed internally or externally relative to the camera body, for example, by a controller, such as a microprocessor/software systems, hardware controller, a combination of these, or other circuitry. Several examples of internal and external detection are described below in detail.

At step 110 a first illumination output change (IOC) signal is generated in response to the detection of the one or more camera body signals in step 105. Like detecting step 105, generating step 110 can be performed internally or externally relative to the camera body, depending on the configuration of the overall control system. For example, if a particular camera body includes an internal controller, generating step 110 can be performed internally. In another example in which a controller is provided externally to a camera body, generation step 110 is performed outside the camera body. As will become apparent from the detailed examples provided below, the first IOC signal can be, for example, a signal recognizable directly by the target modeling lighting device(s) or recognizable by an intermediate device, such as a wireless receiving device that, in turn, generates one or more signals recognizable by the modeling lighting device(s). The relevant signaling depends on the overall configuration of the system. As will also be discussed below, the first IOC signal may be accompanied by and/or contain data, such as one or more power level values and/or a power state change time delay value for a subsequent power change, among others. Examples of such data are described below in the detailed examples.

At step 115 the first IOC signal is transmitted so as to cause one or more modeling lighting devices to operate at a first scene illumination output level. As alluded to above relative to generating step 110, the way the modeling lighting device(s) are caused to operate at the first scene illumination level depends on the configuration of the overall control system. For example, if a particular modeling lighting device has user-settable illumination output level settings that can be input wirelessly, then the system can be configured, for example, so that the IOC signal contains a desired illumination output level setting. In another example, if a particular modeling lighting device has user-settable illumination output level settings that can be input only either through an onboard user interface on the device or through a wired port on the device, then the system may include two wireless devices, a first one at the camera body and a second one connected to the wired input port of the modeling lighting device. In one scenario, the first wireless device at the camera body may transmit a simple modeling-light trigger signal to the second wireless device at the modeling lighting device. In this case, upon receiving the trigger signal the second wireless device would, for example, send the illumination output level setting. If multiple modeling lighting devices are being controlled at the same time via wireless devices, each of these devices may have a unique identifier that a properly configured system can utilize to implement differing control schemes among the multiple devices. Detailed examples of ways of implementing transmitting step 115 are presented below.

After each controlled modeling lighting device has been set to the first scene illumination output level at step 110, at additional step 120, in response to an event each controlled modeling light device is caused to change from the first illumination output level to a second illumination output level. The event at step 120 varies, for example, with the overall system configuration and capability of the controlled lighting device(s). For example, if a particular modeling lighting device has a built-in timer that is wirelessly settable with a delay and the modeling lighting device is able to change the illumination output level from its modeling lamp(s) when the timer times-out on the delay, then the transmission of the first IOC signal at step 115 can be accompanied not only by a desired illumination output level for the first illumination level but also by a delay value and a desired illumination output level for the second illumination level. Then, when the built-in timer times-out on the set delay, the modeling lighting device automatically changes from the first illumination output level to the second illumination output level. In this example, the event at step 120 that causes the first transition to the first illumination level is the initial receipt by the modeling lighting device of the first IOC signal. Similarly, the event at step 120 that causes the second transition from the first illumination level to the second illumination level may be considered the timing-out of the timer that occurs after the timer has been loaded with the transmitted delay value. In another example wherein a controller at the camera body has a timer and the modeling lighting device at issue is responsive to IOC signals containing corresponding respective power level settings, at step 115 the controller sends the first IOC signal containing a power level setting for the first illumination output level and then set its internal time to the desired delay. Then, when the controller's timer times-out on the set delay, at step 120 the controller sends a second IOC signal containing a power level setting for the second illumination output level. In this second example, the event at step 120 that causes the first illumination output level may be considered the receipt of the first IOC signal by the modeling lighting device. Likewise, the event at steps 120 that causes the change from the first illumination level to the second illumination level may be considered the receipt of the second IOC by the modeling lighting device.

A further example includes two wireless devices (such as wireless radio frequency (RF) devices) and a modeling lighting device that has settable illumination output levels but no settable delay. One of the wireless devices is located at the camera body (either internal or external to the camera body) and the other wireless device is located at the modeling lighting device (either internal or external to the lighting device). In the present example, the wireless device at the modeling lighting device includes a built-in timer for implementing any delay settings. In one scenario, at step 115 the wireless device at the camera body sends the first IOC signal to the second wireless devices at the modeling lighting device. When the second wireless device receives the first IOC signal, it then effectively loads a first illumination level setting into the modeling lighting device, which changes the illumination output level of the lighting device in response thereto. In this example, when a controller at the camera body detects another particular occurrence of one or more camera body signals, the first wireless device sends a second IOC signal to the second wireless device. When the second wireless device receives the second IOC signal, it initiates the running of an internal timer based on a preset delay value.

If (when) the timer in the second wireless device times out on the delay value, the second wireless device loads a second illumination level setting into the modeling lighting device. In response to this, the modeling lighting device changes its illumination output level to the second illumination output setting. In this example, step 120 is performed by the various aspects of the sending of the second IOC signal, the starting of the timer at the second wireless device and the loading of the second power level setting by the second wireless device into the modeling lighting device and the responses of the second wireless device and modeling lighting device to, respectively, the set delay and second power output level. In a dual wireless device scenario other variations include, but are not limited to, the first device including the delay timer, the modeling lighting device including the delay timer, the first device being programmed with desired illumination output levels and delay value and the second device being programmed with desired illumination output levels, among others. Those skilled in the art will readily appreciate that there are numerous possible scenarios for performing step 120 and that a description of all of these scenarios is not needed for those skilled in the art to implement the broad concepts disclosed herein in any of the possible scenarios based on the present disclosure. Several particular examples of possible scenarios are described below in detail.

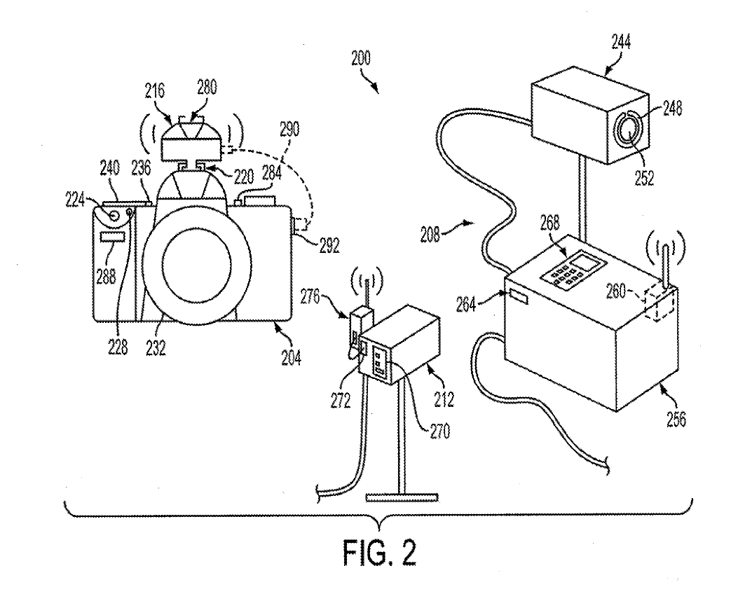

FIG. 2 illustrates an exemplary photographic system 200 that is configured to carry out at least the steps of method 100 of FIG. 1. Referring to FIG. 2, and also to FIG. 1, photographic system 200 includes a camera body 204 and two continuous type modeling lighting apparatuses, namely, a multifunction lighting system 208, which includes a continuous modeling light, and a dedicated modeling lighting device 212. In this example, each modeling lighting apparatus 208, 212 is controllable from camera body 204 via a controller 216 mounted to a hotshoe 220 on the camera body. As described below in detail, controller 216 is configured to control the modeling lighting functionality of multifunction lighting system 208 in one, the other, or both of a wake mode and an autofocus assist mode, depending on a user's preference, and to control modeling lighting device 212 in a backlight control mode. Briefly, wake mode of controller 216 uses a camera body wake signal and a corresponding camera body sleep signal each generated by camera body 204 to control scene illumination output levels of continuous type modeling lighting of multifunction lighting system 208. The wake signal may be generated by any of a variety of controls on camera body 204. However, a very useful control for a photographer to use to initiate the wake signal is a shutter release button 224 on camera body 204, a partial press (commonly referred to as a “half press”) of which causes the camera body to generate a wake signal. The corresponding sleep signal is typically automatically generated by camera body 204, for example, by an internal microprocessor, after a preset time following release of the shutter release or other control.

Autofocus assist (AFA) mode of controller 216 uses a camera body autofocus assist signal generated by camera body 204 to control scene illumination output levels of the modeling lighting of multifunction lighting system 208. In this example, camera body 204 is configured to generate an autofocus assist signal in two ways, a first in response to a user pressing an autofocus (“AF”) button 228 located on the camera body within ready reach of a photographer's thumb and a second in response to the camera body (via autofocus circuitry (not shown)) determining that a lens 232 attached to the camera body needs to be actuated to bring the scene into focus. The generation of camera body autofocus assist signals in both of these manners is well known in the art such that further description is not necessary herein for those skilled in the art to implement the broad concepts disclosed herein.

In this example, backlight (B/L) mode of controller 216 uses a camera body 204 backlighting control signal generated by camera body to control scene illumination output levels of modeling lighting device 212. In this case, camera body 204 includes a backlighting control button 236 that a user uses to turn backlighting of one or more displays, such as LCD display panel 240, on the camera body on and off as desired. It is noted that differing camera body models have differing ways of handling backlighting functionality and signaling. For example, some current camera body models have on—actuators, like backlight control button 236, whereas others have on-switches. In most current camera bodies, each type of actuator is used in conjunction with a built-in timer used to control when the camera body turns the backlighting off. In addition, some current camera body models make the camera body backlighting signaling available at the hotshoe of the camera body, whereas others do not. As will be seen below, camera body 204 of FIG. 2 is of the type that makes camera body backlight signaling available at hotshoe 220. Camera body 204 is also configured like many conventional camera bodies to make camera body wake (and sleep) and autofocus assist signals available at hotshoe 220. Further details of wake, AFA and B/L modes of controller are described below in greater detail after a description of multifunction lighting system 208 and modeling lighting device 212.

In this example, multifunction lighting system 208 includes a dual function lighting head 244 that provides both image acquisition strobe light from a flash source 248 (such as a xenon flash tube) and continuous light from a continuous light source 252 (such as a tungsten bulb). Lighting head 244 is powered by a suitable generator pack 256. A similar multifunctional lighting system is available from Profoto, Stockholm, Sweden, among other photographic lighting manufacturers. Generator pack 256 includes a built-in wireless communications device 260 and an onboard microprocessor (not shown) responsive to a relatively robust set of user-settable lighting control parameters, including modeling lighting control parameters. Parameters for operating multifunction lighting system 208 that a user is able to set/control using wireless communications device 260 include illumination output level settings. In this example, wireless communications device 260 implements a pair of illumination level change delay settings. The use of these parameters and settings is described below in greater detail.

Wireless communications device 260 is in wireless RF communication with controller 216 so as to receive one or more instructions (sets) for controlling the operation of multifunction lighting system 208. In this connection, wireless communications device 260 includes an RF receiver (not shown). In other embodiments, wireless communications device 260 may also include an RF transmitter or, alternatively to separate RF receiver and transmitter, an RF transceiver. It is noted that in yet other embodiments, wireless communications may be implemented using another communication technique, such as visible-light communication (e.g., using a strobe attached to controller 216) and infrared communication, among others.

When an instruction (of instruction set, depending on the communication protocol) containing a power level setting is received by the built-in microprocessor of generator pack 256 (for example via built-in wireless communications device 260, an external port 264 or a built-in user interface 268), the onboard microprocessor changes the output illumination level of continuous light source 252 to the setting provided in that instruction (set). If a delay value is not also provided with the instruction (set), continuous light source 252 will stay at the new setting until the microprocessor receives another power state instruction, such as another illumination output setting or a power-off instruction. However, when the onboard microprocessor of generator pack 256 receives an instruction (set) containing first and second power level settings and a delay setting, the built-in microprocessor first changes the illumination output of continuous light source 252 to the first power level setting, holds the illumination output for the delay setting and then changes the illumination output to the second power level setting. The power level setting may be expressed in any convenient form, such as percentage of maximum output power, absolute input power or absolute output power, among others. The delay setting may also be expressed as any convenient value, such as number of seconds, minutes or other predefined periods.

In this example, modeling lighting device 212 is a standalone modeling lighting device that utilizes a continuous light source (on hidden side of device 212, but such as a tungsten bulb, a light-emitting diode (LED) or an array (panel) of LEDs) to provide continuous light at a user-selectable illumination output level. Such a tungsten-bulb-based modeling lighting device is available from Elinca, Geneva, Switzerland, among other photographic lighting manufacturers. Modeling lighting device 212 includes an onboard controller (not shown) that can be set to any one of various illumination output levels via either of an integrated user interface 270 and a wired communications port 272. Because modeling lighting device 212 does not have a built-in wireless communications device like generator pack 256, the modeling lighting device is supplemented with an external RF wireless communications device 276 that is in wired communication with wired communications port 272 of the device. In this example, modeling lighting device 212 is configured to be toggled between two user-preset illumination output levels set by a user via integrated user interface 270 in response to it receiving a certain trigger signal. Consequently, wireless communications device 276 is in wireless RF communication with controller 216 so as to receive first and second IOC signals (which may be the same as one another) that cause wireless communications device 276 to provide each certain toggling trigger signal to modeling lighting device 212. In this connection, wireless communications device 276 includes an RF receiver (not shown). In other embodiments, wireless communications device 260 may also include an RF transmitter or, alternatively to separate RF receiver and transmitter, an RF transceiver. It is noted that in yet other embodiments, wireless communications may be implemented using another communication technique, such as visible-light communication (e.g., using a strobe attached to controller 216) and infrared communication, among others.

In this example, wireless RF communications among controller 216, wireless RF communications device 260 of generator pack 256 and wireless RF communications device 276 of modeling lighting device 212 includes the ability of each of these devices to distinguish signaling meant for it from signaling meant for any other device. This can be accomplished in any of a variety of ways, such as by each device having a unique address and including in each transmission the unique address(es) of the device(s) intended to receive a particular transmission. Further detail of such signaling techniques is beyond the scope of this disclosure and is not needed for those skilled in the art to implement such techniques, since they are known in the art.

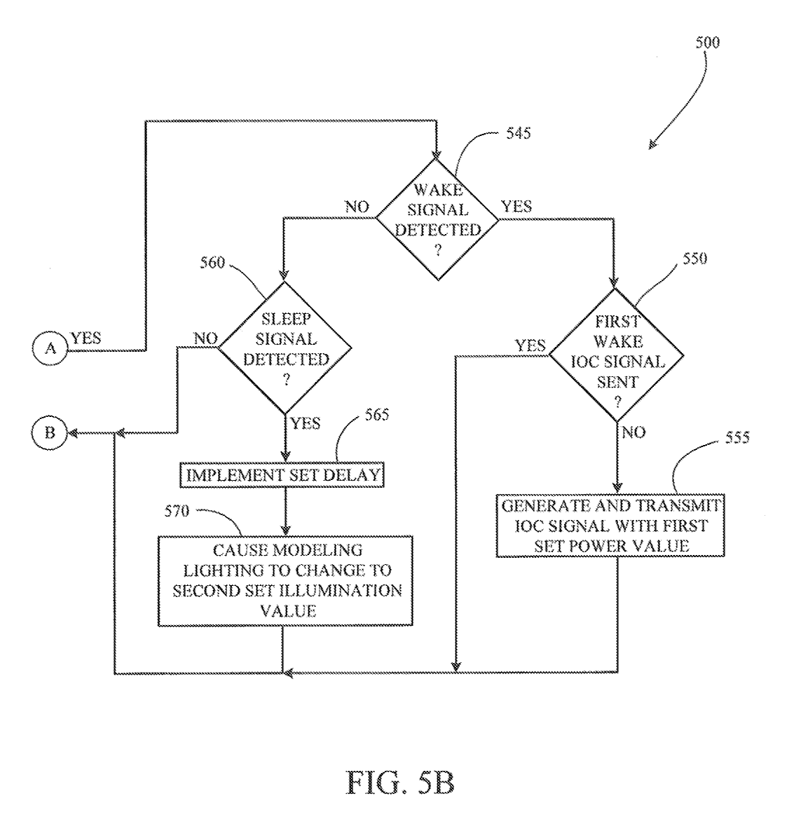

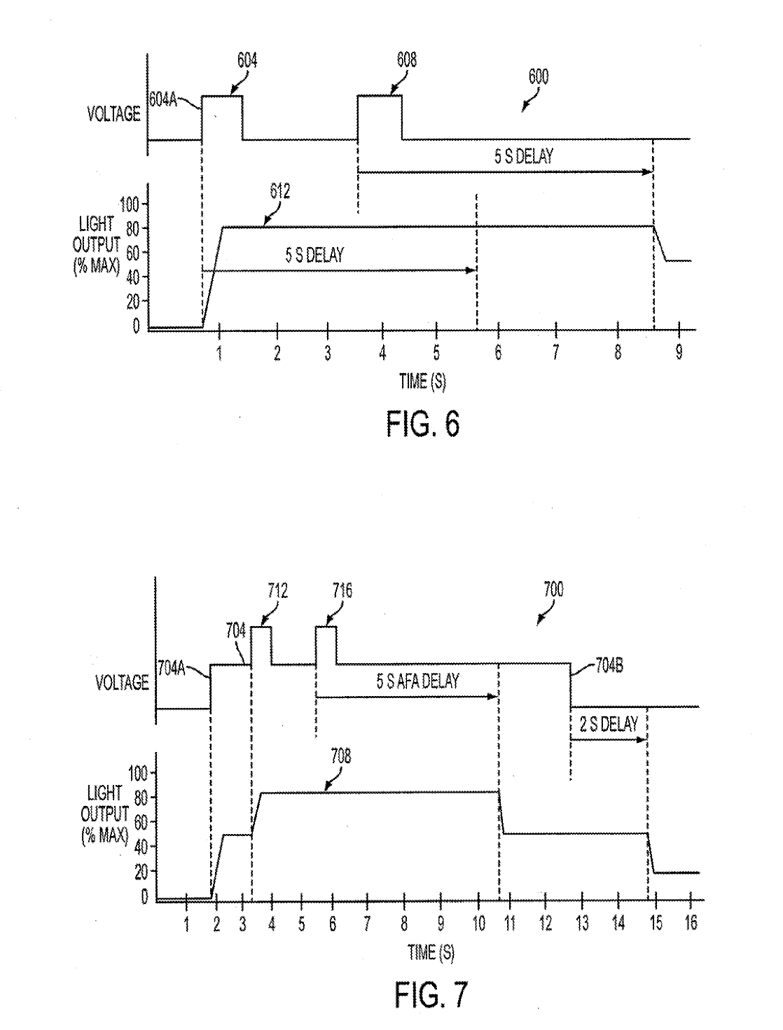

As those skilled in the art will readily appreciate, hotshoe 220 has a number of electrical contacts (not shown) for communicating various signals to and/or from an accessory, typically a flash device or strobe-controlling radio, mounted to the hotshoe. In this example, camera body 204 is of a type that outputs a camera body wake/sleep signal(s) via one of the pins, denoted the first pin, and outputs a camera body autofocus assist signal via the same first pin. Also in this example, the camera body wakeup signal is characterized by a first voltage change, here from a low level to an intermediate level, the camera body sleep signal is characterized by a second voltage change, here from the intermediate level to the low level, and camera body autofocus assist signal is identified by a third voltage change, here from the intermediate level to a high level. This example is discussed further below in connection with FIGS. 6 and 7. Further, in this example the camera body backlight control signal appears on a second pin different from the first pin and is identified by an increase in voltage from a low voltage to a higher voltage that is held high while the backlighting is to be on. It is noted that some current camera bodies, such as EOS-series SLRs/DSLRs available from Canon, Inc., Tokyo, Japan, do not provide backlight signals externally through a hotshoe, whereas other current camera bodies, such as SLRs/DLSRs available from Nikon Corporation, Tokyo, Japan, provide backlight on/off information via a status bit in a digital communications bit cluster, for example to allow the camera-body backlighting control signal to control backlighting on a flash unit mounted to the hotshoe. Other camera bodies can have different backlighting signaling arrangements, such as the one illustrated in FIGS. 6 and 7.

Another characteristic of this example is that backlight control mode is of a non-delay-type. That is, the camera body backlighting stays on until a user turns it off, here, using backlighting control button 236. Consequently, when a user activates camera body backlight control button 236 to turn camera body backlighting on, controller 216 is configured to cause a first illumination output change in modeling lighting device 212, here from off to on. (In this example, the photographer wants modeling lighting device 212 to be on when the backlighting of camera body 204 is on. However, there may be other situations when the photographer might want modeling lighting device 212 to be off when backlighting of camera body 204 is on. These differing options are described in more detail below.) Then, when the user activates backlight control button 236 again to toggle the camera body backlighting off, controller 216 is configured to cause a second illumination output change in modeling lighting device 212, here from on to off. Further details of this control scheme are provided below.

In the current embodiment, controller 216 is not (though it could be) part of a hotshoe-mountable flash device that is fully compatible with camera body 204 (i.e., is able to use any signaling camera body 204 makes available via hotshoe 220), although such a flash device (not shown), or other flash or non-flash device, may indeed be mounted on the controller via an auxiliary hotshoe 280 that has the same signals available as the signals available at hotshoe 220. Nonetheless, in this example, controller 216 is configured to utilize some of the same information that camera body 204 normally provides to a compatible flash device via hotshoe 220. Often, however, conventional camera bodies do not provide their hotshoes with any signaling, i.e., wake, sleep, autofocus assist, backlighting, etc., if they do not recognize that a compatible device has been engaged with the hotshoe. Consequently, in such cases, wireless controller 216 can be configured with an appropriate system for causing camera body 204 to provide the needed signals. U.S. patent application Ser. No. 12/129,402 filed on May 29, 2008, and titled “System and Method For Maintaining Hotshoe Communications Between A Camera and A Wireless Device,” discloses such systems and is incorporated herein by reference for all of its teachings on these systems.

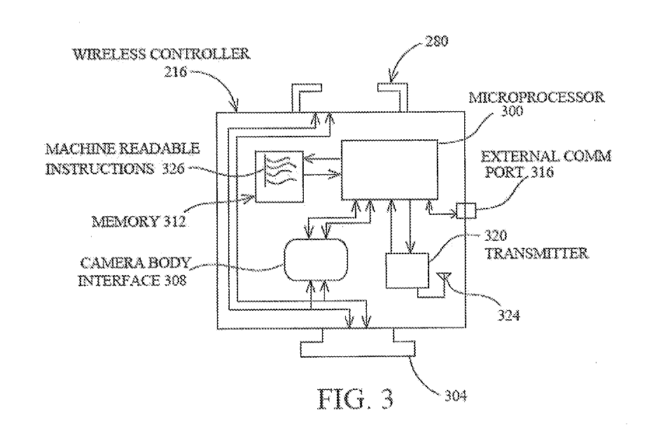

Referring now to FIG. 3, and also to FIG. 2, in this example controller 216 includes, among other things, a microprocessor 300, a hotshoe connector 304, a camera body signal interface 308, memory 312, an external communications port 316, an RF transmitter 320 and an antenna 324. It is emphasized at this point, and will be recognized by those skilled in the art that the components of this example and their arrangement are presented for the sake of illustration and not limitation. Skilled artisans will understand that given the wide range of technologies available for implementing the overarching functionality disclosed herein, there are many ways of implementing this functionality. For example, while the various parts of controller 216 are shown as components discrete from one another, any two or more of the parts can be integrated onto a single integrated circuit chip, for example, as a system on chip. Similarly, various ones of the differing parts can be integrated with one another. For example, any memory provided may be partially or completely integrated with, for example, the microprocessor.

Further variations include the fact that RF transmitter 320 and corresponding antenna 324 can be replaced by another type of transmitting system, such as an infrared or visible light transmitter. An analog of the latter is a hotshoe mounted strobe device capable of sending data wireless to a remote strobe device using specially timed pulsed emissions from a flash tube. In still further variations, the parts of controller 216 provided to enable its functionality externally relative to a camera body, such as camera body 204 of FIG. 2, can be eliminated and most of the remaining parts adapted for location inside a camera body, except perhaps for an antenna, strobe, or other wireless signal transmitting device. In the case of putting the functionality of a controller of the present disclosure, such as controller 216, into a camera body, this can be accomplished by retrofitting an existing camera body or by designing the functionality into a new camera body design prior to production. In the latter case, any microprocessor(s)/circuitry used for the modeling lighting control functionality disclosed herein could be the same microprocessor(s)/circuitry that controls conventional camera functionalities. In yet other variations, any microprocessor/software implementation envisioned herein could be replaced by a purely hardware implementation at the choice of the designer. It is also noted that depending on the nature of the particular controller, the transmitter could be supplemented with a receiver, or both could be replaced by a transceiver without departing from the spirit of the embodiments disclosed and intended to be covered by the appended claims.

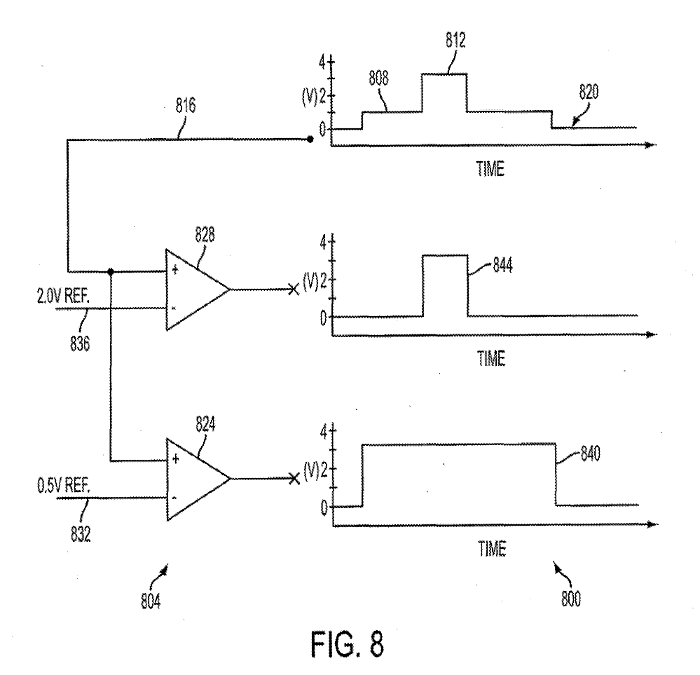

Returning now to the illustrative example, microprocessor 300 performs a host of functions including, but not limited to, executing machine-executable instructions 326 (e.g., firmware stored in memory 312), communicating with camera body interface 308, controlling/communicating with communications port 316, controlling/communicating with transmitter 320 and providing wireless controller 216 with its unique functionality. Camera body interface 308 receives signals from a camera body, such as camera body 204 of FIG. 2, for example via hotshoe 220, and transforms those signals as needed for use by microprocessor 300. Signals that camera body interface 308 is configured to transform in this example are a camera body wake/sleep signal, a camera body autofocus assist signal and a camera body backlight signal. An example of circuitry suitable for use in camera body interface 308 when these signals are analog voltage signals is described below in connection with FIG. 8. It is noted, however, that not all camera systems use analog signals to communicate information such as wake, sleep, autofocus assist, and backlight on/off externally from the camera body. Other camera systems handle such communication digitally, for example, using digitally encoded signals. In such cases, the camera body interface may simply be a data link to the microprocessor. Yet other camera systems may implement a hybrid approach wherein one or more signals are analog and one or more signals are digitally encoded. In the context of a microprocessor-based controller, the camera body interface would be configured to handle both types of signaling.

As alluded to above, memory 312 is used generically in FIG. 3 to denote any and all types of memory in communication with controller 216, including BIOS memory and RAM, among others, that are, as mentioned above, integrated into microprocessor 300 and/or provided externally to the microprocessor. Memory 312 contains information wireless controller 216 needs to perform its functionality, such as, but not limited to: machine-executable instructions 326 for enabling the functionality of the controller; controller setup data; controlled modeling light device parameter settings (such as illumination output levels and delay values); controlled device instructions (sets); and communications settings, e.g., transmit (and receive) frequencies, device identification codes, etc., among other things. Those skilled in the art will understand all of the various types of information that can/needs to be stored in memory 312 to make controller 216 a device that functions according to the concepts disclosed herein.

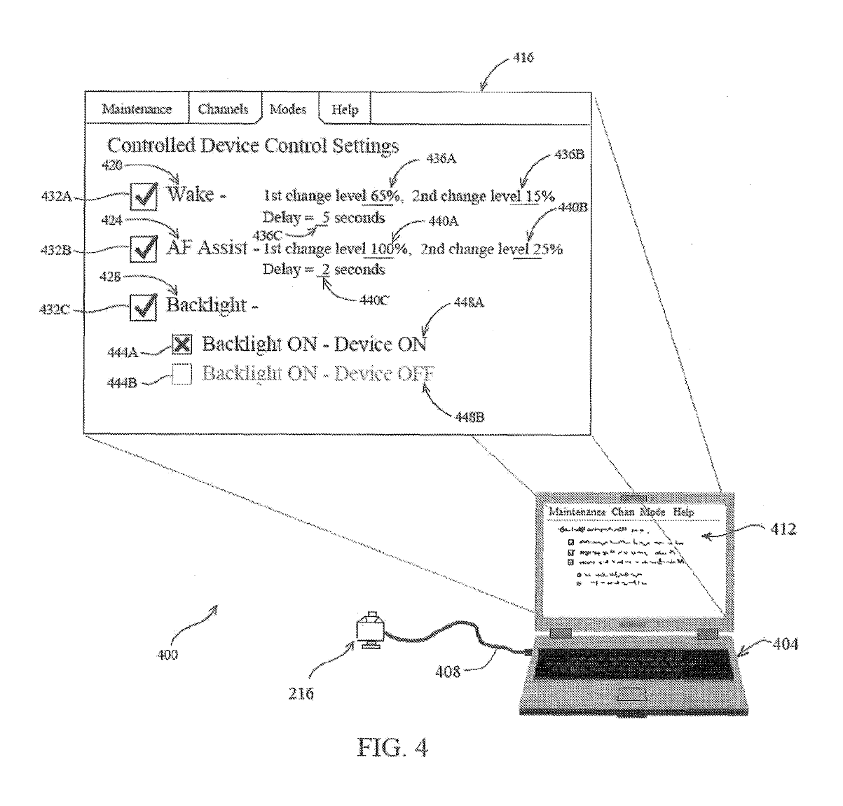

Continuing with this illustrative example, external communications port 316 is provided for transferring information to and from controller 216. This allows a user to custom configure controller 216 and provide any needed operational settings for a particular application of the controller. In the present example, communications port 316 is a USB port. However, any other type of communications port, including a wireless port (e.g., Bluetooth, IEEE 802.11, etc.), can be provided in place of or in addition to USB port 316. In this connection, FIG. 4 illustrates controller 216 in an information transfer environment 400. In this example, controller 216 is connected to a suitable programming device, such as laptop computer 404 shown, via a USB cable 408 (since in this example external communications port 316 is a USB port). Laptop computer 404 provides a convenient vehicle for presenting to a user a graphical user interface (GUI) 412 of a software application (not shown, but running on the laptop computer in a conventional manner) designed for interacting with controller 216. GUI 412 is shown presenting a screen 416 that allows a user to select which mode(s) of device control operation the user desires to enable and also allows a user to set the appropriate parameter(s) for each of the selected modes.

It is noted that the example shown in FIG. 4 is simply that, exemplary. In other implementations the programming of a controller made according to the present disclosure can be accomplished in any one or more of a number of ways. For example, the controller can be provided with a user-interface, such as an LCD screen and one or more buttons or other input devices, a touchscreen, etc. that allow a user to program the controller. In other implementations, control parameter values for the controller can be set with one or more mechanical buttons, switches and/or dials, etc. In yet other implementations, control parameter values can be set wirelessly, for example, using a wireless port as mentioned above. In such a case, the programming device could be a smartphone (e.g., BlackBerry device, iPhone device), PDA, laptop computer, desktop computer, dedicated programming device, etc. Those skilled in the art will understand and appreciate the variety of ways that a controller of the present disclose can be programmed with desired control parameter values, if the controller is not preset with the desired values or is not programmable.

As mentioned above, in the present example, controller 216 is configured to have control functionality based on camera body wake signals (“Wake” mode 420), camera body autofocus assist signals (“AF Assist” mode 424) and camera body backlight controls signals (“Backlight” mode 428). Correspondingly, GUI 412 provides three primary selection controls (here a common GUI-type checkboxes 432A-C) corresponding respectively to the three modes 420, 424, 428. As will be seen below, a user can select any one, any two or all three of these modes 420, 424, 428, as desired.

If a user selects checkbox 432A indicating Wake mode 420, the wake mode parameter selection input fields 436A-C become active. In this example, Wake mode selection fields 436A-C are for inputting three desired values, respectively: 1) a first illumination output level, in this example the illumination output level to which to change the modeling lighting of multifunctional lighting system 208 (FIG. 2) as a function of controller 216 detecting a camera body wake signal; 2) a second illumination output level, here the illumination output level to which to change the modeling lighting of the multifunctional lighting system from the first illumination output level; and 3) a delay value used to determine when to cause the second illumination output level change. In this example, illumination output levels are expressed as a percentage of the maximum illumination output and the delay value is expressed in seconds.

If a user selects checkbox 432B indicating AF Assist mode 424, the autofocus assist parameter selection input fields 440A-C become active. In this example, autofocus assist mode selection fields 440A-C are for inputting three desired values, respectively: 1) a first illumination output level, in this example the illumination output level to which to change the modeling lighting of multifunctional lighting system 208 (FIG. 2) as a function of controller 216 detecting a camera body wake signal; 2) a second illumination output level, here the illumination output level to which to change the modeling lighting of the multifunctional lighting system from the first illumination output level; and 3) a delay value used to determine when to cause the second illumination output level change. In this example, illumination output levels are expressed as a percentage of the maximum illumination output and the delay value is expressed in seconds.

If a user selects checkbox 432C indicating Backlight mode 428, a pair of parameter selection checkbox controls 444A-B become active. In this example, Backlight mode 428 has two sub-modes 448A-B. In first sub-mode 448A, the controlled device (here, modeling lighting device 212 (FIG. 2)) is turned on when a user turns on the camera body backlighting and is turned off when the user turns off the camera body backlighting. In second sub-mode 448B, the controlled device is turned off when a user turns on the camera body backlighting and is turned on when the user turns off the camera body backlighting. It is noted that in alternative embodiments each of first and second sub-modes 448A-B may be provided with power level fields similar to the power level fields of Wake and AF Assist modes 420, 424. However, in this example, modeling lighting device 212 (FIG. 2) is either switched on or off, so no power levels need to be set. Rather, the on- and off-signaling from controller 216 to modeling lighting device 212 will be handled properly depending on which sub-mode 448A-B is selected. That is, if first sub-mode 448A is selected, the software application running on laptop computer 404 configures controller 216 to send an on-signal to wireless communications device 260 (FIG. 2) when a user turns on the backlighting of camera body 204 and to send an off signal to that wireless communications device when the user turns off the camera body backlighting. The opposite is true of second sub-mode 448B. In another alternative in which the power state change is binary, i.e., off-on-off or on-off-on, GUI 412 may be provided with two power level fields (not shown) corresponding to the two changes. These fields may be identical to fields 436A-B, 440A-B of, respectively, Wake mode 420 and AF Assist mode 424. Then, if a user wants off-on-off functionality, the user would input 100% power for the first power level change (corresponding to the off-on transition) and 0% power for the second power level change (corresponding to the on-off transition). Of course, other alternatives are possible.

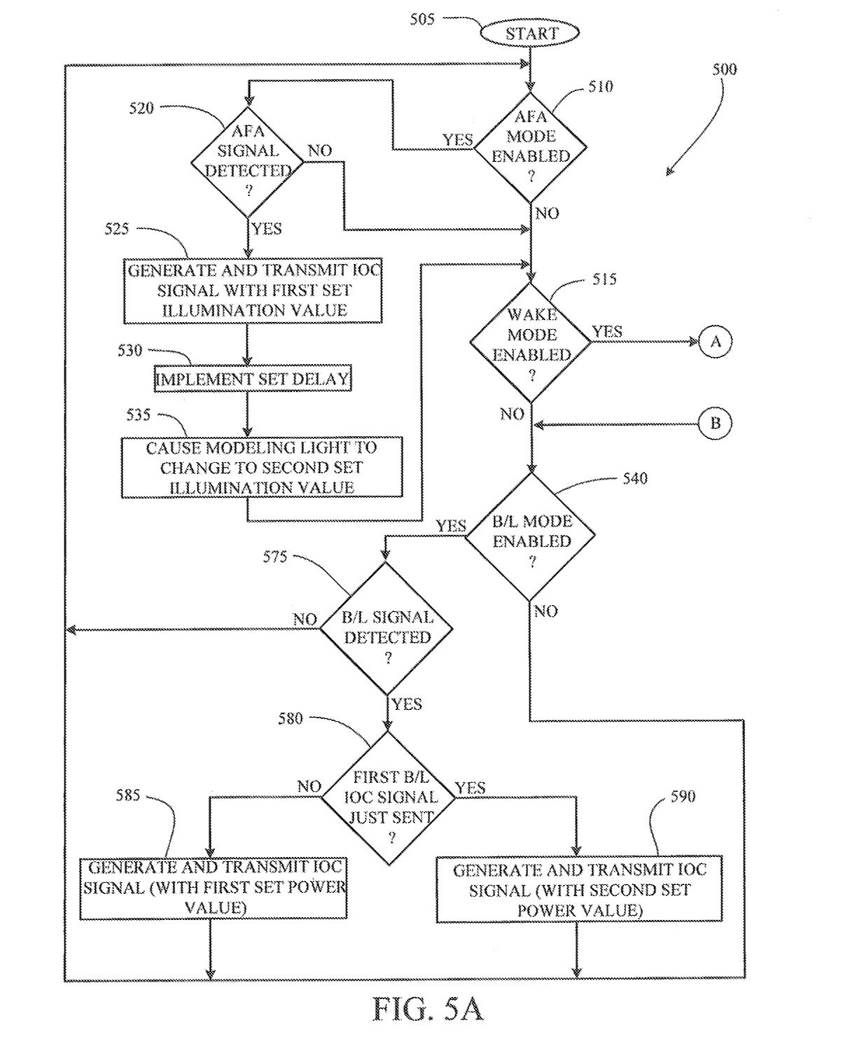

FIGS. 5A-B illustrate a flow diagram illustrating one possible method 500 of controlling controller 216 so as to provide the controller with the functionality illustrated via GUI 412 of FIG. 4. As those skilled in the art will readily appreciate, method 500 can be implemented in software, in analog circuitry and in any combination thereof. At step 505 method 500 begins. Depending on the power state of controller 216, step 505 may begin when the controller is first powered on and, if the controller has wake and sleep states to control power consumption, every time the controller is woken up. At step 510 the controller determines (or already knows) whether or not AF Assist (AFA) mode 424 is enabled. As discussed above relative to GUI 412 (FIG. 4), AF Assist mode 424 may be enabled during an appropriate setup procedure, for example, by a user checking checkbox 432B in the GUI with controller 216 in communication with laptop 404. If AF Assist mode 424 is not enabled, method 500 continues to step 515 wherein controller 216 checks to determine whether Wake mode 420 has been enabled, for example, in a manner similar to AF Assist mode 424.

However, if at step 510 controller 216 determines (or knows) that AF Assist mode 424 is enabled, then method 500 proceeds to step 520 at which the controller determines whether or not it has detected an AFA signal generated by camera body 204 (FIG. 2). If controller 216 has not detected camera body AFA signal, method 500 simply proceeds to step 515 to determine whether Wake mode 420 is enabled. On the other hand, if controller 216 has detected a camera body AFA signal, at step 525 controller 216 generates and transmits an illumination output change signal. In this example, since generator pack 256 (FIG. 2) of multifunction lighting system 208 has built-in wireless communication device 260 and is responsive to instructions containing illumination level settings, step 525 includes transmitting the first change level set in field 436A of GUI 412. In this example, controller 216 transmits the first change level signal as soon as possible after it detects the camera body AFA signal.

At step 530 controller implements the delay set in field 436C of GUI 412. In this example, generator pack 256 has an internal timer and is responsive to wirelessly received instructions that include delay values. Consequently, in one example when controller 216 transmits the IOC signal along with the first illumination level at step 525, at the same time it transmits the set delay value. Those skilled in the art will understand that other implementations can utilize a timer function built into the controller. At step 535, controller 216 causes the modeling light to change to the second change level set in field 436B of GUI 412. In the present example in which generator pack 256 is responsive to a robust instruction set, controller 216 performs step 535 by sending the second change level along with the delay value and first change level that the controller sends at step 525. Generator pack 256 then implements the change of the modeling light of multifunction lighting system 208 to the second change level after the internal timer of the generator pack times-out on the set delay value. If in another implementation controller 216 provides the timer functionality, the controller could send a second IOC signal containing the second change level in response to the timer timing out. Still further options are possible, depending on the particular capabilities of the modeling lighting devices at issue. It is noted that the flow diagram for method 500 does not capture other steps that can be implemented to provide various other operating features that may be needed to provide desired operation. For example, once controller 216 detects a camera body AFA signal at step 520, it may be desirable to disable Wake mode 420 and/or backlight (B/L) mode 428 to prevent the controller from changing the modeling lighting to an illumination output level unsuitable for assisting autofocusing.

After controller 216 performs step 535, example method 500 proceeds to step 515 at which the controller determines (or knows) whether or not Wake mode 420 is enabled. If Wake mode 420 is not enabled, method 500 proceeds to step 540 at which controller 216 determines (or knows) Backlight (B/L) mode 428 is enabled. However, if Wake mode 420 is enabled (step 515), at step 545 controller 216 determines whether or not it detects a camera body wake signal. In this example (as seen further below in connection with FIG. 7), the camera body wake signal is an analog signal indicated by an intermediate-level rise in a line voltage on the first pin of hotshoe 220 (FIG. 2). (In this example, a high level rise in that line voltage indicates the presence of an AFA signal (see FIG. 7 and accompanying description.) When this line voltage is at the intermediate-level voltage, the camera body wake signal is said to be present. Correspondingly, a drop in the line voltage from the intermediate-level voltage corresponds to a sleep signal.

If controller 216 detects a camera body wake signal at step 545, method 500 proceeds to step 550, which in this example is implemented because the method is set up to continually loop through the various branches of the method. At step 550, controller 216 determines whether or not it has already sent a first IOC signal based upon an earlier recognition that the camera body wake signal was high (in this example, at the intermediate-level voltage). If controller 216 has not already sent such first IOC signal, method 500 proceeds to step 555, wherein the controller generates and transmits that first IOC signal. As will be seen below relative to FIG. 7, in this example, step 555 essentially causes the modeling lighting of multifunction lighting system 208 to change almost instantaneously after the leading edge of the line voltage begins to rise toward the intermediate level. In this example, the sending of the first IOC signal at step 555 includes sending to wireless communications device 260 (FIG. 2) of generator pack 256 the first change level noted in field 440A of GUI 412. After controller 216 sends the first IOC signal at step 555, method 500 proceeds to step 540 so as to continue the looping. If at step 550 controller 216 determines that the first IOC signal from step 555 was sent previously since the current camera body wake signal became present, method 500 proceeds to step 540 and continues the continual looping.

If at step 545 controller 216 did not detect a wake signal, then method 500 proceeds to step 560 at which the controller detects whether a camera body sleep signal has occurred. If a camera sleep signal has not occurred, method 500 proceeds to step 540 to continue the looping nature of the method. In this example, the user-set delay value present in field 440C of GUI 412 (FIG. 4) is implemented relative to the camera body sleep signal. Since wireless communication device 260 includes a built-in timer, when controller 216 detects a camera body sleep signal at step 560 it proceeds to step 565 in which it implements the set delay value from field 440C. In this example, controller 216 accomplishes step 565 by transmitting to wireless controller a second IOC signal that includes the second change level setting set in field 440B of GUI 412, along with a set-timer instruction and the delay value set in field 440C of GUI 412. At step 570 controller 216 causes the modeling lighting of multifunction lighting system 208 to change to the second change level set in field 440B of GUI 412. Again, controller 216 performs step 570 by way of the transmitting of the set delay value to wireless communications device 260 at the same time as the second change level setting. Generator pack 256 then changes the illumination output level of the modeling lighting to the second change level when the timer in second wireless communications device times out on the delay. In other embodiments, steps 565 and 570 can be handled differently. For example, if controller 216 were to have the timer functionality, step 565 could involve the controller setting the timer, and step 570 could involve the controller transmitting the second change level upon timing out of the timer. Of course, other possibilities exist. It is noted, too, that the delay could be initiated, for example, from the initial wake signal detection rather than the sleep signal detection. After controller has performed steps 565, 570, method 500 loops back to step 540.

In another variation in which wireless communications device 260 at generator pack 256 includes a built-in timer to handle the delay values set in fields 436C, 440C of GUI 412, this communications device may be augmented with additional timer functionality to account for instances where either camera body 204 never generates, in this example, a sleep signal (such as when a user turns the camera body off while it is still awake) or controller 216 never transmits a second IOC signal (such as when a user turns off the controller before detecting a sleep signal and/or transmitting the second IOC) or a receiver failing to receive a second IOC signal, for example, because of interference between the transmitter and receiver. In such a case, wireless communications device 260 can include a second timer that is reset with a delay value (herein called an “inactivity delay value”) each time it receives a first IOC signal. This inactivity delay value will typically be stored in wireless communications device 260 and should be a value greater than any reasonably anticipated value for either of the delay values set in fields 436C, 440C of GUI 412 (FIG. 4). In one example, the inactivity delay value is set to 10 minutes, though many other values may be used.

In conjunction with the inactivity delay value, wireless communications device 260 may also be programmed with a inactivity illumination output value setting that the wireless communications device can load into generator pack 256 if the wireless communications device's timer times out on the inactivity delay value, for example, if it never receives a second IOC signal in the normal course of method 500. Again, this can happen in this example if camera body 204 never generates a sleep signal and/or controller 216 never transmits a second IOC signal, among other events. The inactivity illumination output value setting may be the same as, or different from, either or both of the illumination output value settings in fields 436B, 440B of GUI 412.

At step 540, if controller 216 detects (or knows) that Backlight (B/L) mode 428 (FIG. 4) is not enabled, method 500 simply loops back to step 510. However, if Backlight mode 428 is enabled, at step 575 controller 216 determines whether or not a camera body B/L signal (e.g., either an on or off signal) has occurred. If not, method 500 simply loops back to step 510. However, if controller 216 detects a camera body B/L signal at step 575, it proceeds to step 580 to determine whether or not it has already sent a first IOC signal at step 585 to modeling lighting device 212 (FIG. 2), in this case simply a toggling signal. If controller 216 determines it has not sent the first IOC signal, method 500 proceeds to step 585 and sends that signal. It is noted that if modeling lighting device 212 were so enabled to respond to transmitted first and second change levels, the transmission of the relevant signaling at step 585 could include such a level value. After controller 216 generates and transmits an IOC signal at step 585, method 500 loops back to step 510. If, however, at step 580 controller 216 determines that it has already sent a first IOC signal (e.g., in response to a user turning camera body backlighting on), method 500 proceeds to step 590 at which the controller generates and transmits a second IOC signal (here, simply another toggle signal), for example, in response to the user turning the camera backlighting off. After controller 216 generates and transmits an IOC signal at step 590, method 500 loops back to step 510. It is noted that as with additional optional steps of method 500 relating to AF Assist mode 424, various additional optional steps may be added relative to Wake and Backlight modes 420, 428. For example, various disabling steps and/or interrupt steps may be added to disable certain functionality and/or to allow ones of the various modes to interrupt one another. Those skilled in the art will readily understand how to implement the illustrated and other steps using well known programming and/or circuit design techniques.

Referring now to FIGS. 6-8, and also to FIGS. 2 and 4, FIGS. 6-8 illustrate example timing diagrams 600, 700, 800 for scenarios involving ones of the Wake and AF Assist modes 420, 424 (FIG. 4). As mentioned above, these diagrams 600, 700, 800 are for a camera body, such as camera body 204 of FIG. 2, that communicates wake and autofocus assist signals via common hotshoe contacts as analog voltage signals, as opposed to digital data packet signals. That said, as mentioned above those skilled in the art could readily implement the same sort of control scheme in a digital instruction signaling environment that uses digital packet signal analogs to the analog voltage signals. In timing diagrams 600, 700, the settings for Wake mode 420 are: first power change level=50%; second power change level=15%; delay=2 seconds, and the settings for AF Assist mode 424 are: first power change level=80%; second power change level=60%; delay=5 seconds. These settings are shown on screen 416 of FIG. 4.

Referring to FIGS. 2, 4 and 6, timing diagram 600 of FIG. 6 is an example in which only AF Assist mode 424 is enabled. In this example, camera body 204 (FIG. 1) has generated first and second AFA signals 604, 608 approximately 2 seconds apart from one another. Camera body 204 may generate each AFA signal 604, 608 in any number of ways, such as in an automatic mode in response to a user performing a half-press on shutter release button 224 of the camera body or in response to the user pressing a dedicated AF button 228 of the camera body. When wireless controller 216 first detects the leading edge 604A of first AFA signal 604, in this example, it generates and transmits a modeling light instruction (set) containing the first power change level, the second power change level and the delay values set, for example, via GUI 412 of FIG. 4. Once generator pack 256 receives this instruction (set), as represented by modeling light illumination output curve 612 it changes the output level of the modeling light to the first power change level (here, 80%) from whatever level the modeling light was set to prior to receiving the instruction (set) (here, 0%) and starts a delay timer (not shown) internal to the modeling light using the preset delay value (here, 5 seconds).

If controller 216 does not detect another AFA signal in about 5 seconds from detecting first AFA signal 604, i.e., in about the time of the delay value, the built-in timer of wireless communications device 260 will time-out and this wireless device will initiate via generator pack 256 the second power level change of the modeling light to the preset level (here, 60%). However, in the case illustrated in FIG. 6, within about 2 seconds of detecting first AFA signal 604, controller 216 detects second AFA signal 608, which in this example causes the controller to send the same instruction (set) it sent in response to the detection of the first AFA signal. When wireless communications device 260 receives this second instruction (set), it initiates the first power level change (which is not actually a change since the first power change level had already been set in response to first AFA signal 604) of the modeling light and re-sets its internal timer to the preset delay value. Since in this example controller 216 does not detect another AFA signal within about 5 seconds (again, the preset delay) of second AFA signal 608, after the built-in timer of wireless communications device 260 times out, as seen by modeling light illumination output curve 612, this communications device initiates the second power change and changes the modeling light output level to the second power change level (here, 60%).

Referring now to FIGS. 2, 4 and 7, timing diagram 700 of FIG. 7 is an example for a scenario in which both Wake and AF Assist modes 420, 424 are enabled. In this example, when the controller 216 detects a leading edge 704A of a wake signal 704, it generates and transmits a modeling light instruction (set) that contains the first power change level. When wireless communications device 260 receives that instruction (set), as illustrated by modeling light illumination output curve 708, it changes via generator pack 256 the modeling light output level from whatever level it was previously set to (here 10%) to the first power change level (here, 50%). As seen from timing diagram 700, while camera body 204 remains awake (and correspondingly, wake signal 704 remains high), the camera body generates first and second AFA signals 712, 716, in this example 1.5 seconds apart from one another. When controller 216 detects the leading edge 712A of first AFA signal 712, it generates and transmits a modeling light instruction (set) in a manner essentially the same as described above relative to FIG. 6. This instruction (set) includes the first power change level, the second power change level and the delay for the AF Assist mode (here, respectively, 80%, 60%, 5 seconds). Upon receiving such instruction (set), as seen by modeling light illumination output curve 708, generator pack 256 changes its modeling light power output to 80% and sets its internal timer to 5 seconds.

Like the example of FIG. 6, if controller 216 does not detect another AFA signal in about 5 seconds from detecting first AFA signal, i.e., about the time of the AF Assist mode delay value, the built-in timer of wireless communications device 260 will time-out and will cause generator pack 256 to make the second power level change to the preset level (here, 60%). However, in the scenario illustrated in FIG. 7, within about 1.5 seconds of detecting first AFA signal 712, controller 216 detects second AFA signal 716, which in this example causes the controller to send the same instruction (set) it sent in response to the detection of first AFA signal. When wireless communications device 260 receives this second instruction (set), as seen by modeling light illumination output curve 708, it initiates via generator pack 256 the first modeling light power level change (which is not actually a change since the first power change level had already been set in response to first AFA signal 712) and re-sets the communications device's timer to the preset delay value. Since in this example controller 216 does not detect another AFA signal within about 5 seconds (again, the preset delay) of second AFA signal 512, after the built-in timer of wireless communications device 260 times out, as seen by modeling light illumination output curve 508, the communications device initiates the second power change and changes the output level of the modeling light to the second power change level (here, 60%).

In this example, after the timer internal to wireless communications device 260 has timed out from second AFA signal 716, camera body 204 is still awake for a few seconds, as indicated by wake signal 704 still being high. Camera body 204 may remain awake, for example, because a user continues to hold shutter release button 224 at half-press. However, once controller 216 detects the trailing edge 704B of wakeup signal 704 (i.e., a sleep signal), it generates and transmits to wireless communications device 260 a modeling light instruction (set) containing the wakeup mode second power change level (here, 15%) and the wake mode delay (here, 2 seconds). When wireless communications device 260 receives this instruction (set), it sets its internal delay timer to 2 seconds. When the internal timer times out, as seen by modeling light illumination output curve 708, wireless communications device causes generator pack 256 to change its modeling light output level from the current level (here, the 60% level from the second power change of AF Assist mode 424) to the second power change level (here, 15%). As described above, if controller 216 is so enabled, after this last transmission it may enter a sleep mode to save power.

FIG. 8 illustrates example circuitry 804 that may be used in, for example, camera body interface 308 (FIG. 3) of controller 216 (FIGS. 2 and 3) to convert “raw” camera body wake and AFA signals 808, 812 available, in this example, at hotshoe 220 of camera body 204 to signals suitable for use in microprocessor 300 of the controller. In the context of example circuitry 804, camera body wake and AFA signals 808, 812 are of the same analog character as the like signals 604, 608, 704, 712, 716 of FIGS. 6 and 7, above. More precisely, in this example, wake signal 808 is characterized by a rise in voltage from a low voltage (here, 0V) to a midlevel voltage (here, 1V), and autofocus signal 812 is characterized by a rise in voltage from the midlevel voltage to a high voltage (here, 3.5V).

Circuitry 804 includes an input 816 that carries an input voltage signal 820 that contains wake and AFA signals 808, 812 when they occur. Input 816 is electrically coupled to inputs of corresponding respective first and second comparators 824, 828 that each compare input voltage signal 820 to a particular reference voltage on a corresponding reference voltage line 832, 836. Here, the reference voltage for first comparator 824 is 0.5V, which allows the first comparator to output a wake-signal-present signal 840 when wake signal 808 is present on input 816. Similarly, the reference voltage for second comparator 828 is 2V, which allows the second comparator to output an AFA-signal-present signal 844 when AFA signal 812 is present on input 816. In this example, wake-signal-present and AFA-signal-present signals 840, 844 are provided as inputs to microprocessor 300 (FIG. 3). If the I/O voltage regime of microprocessor 300 is 0V to 3.3V, then the wakeup-signal-present and AFA-signal-present signals 840, 844 output from comparators 824, 828 are either about 0V or about 3.3V, depending on whether corresponding wake and AFA signals 808, 812 are present on input voltage signal 820. Of course, those skilled in the art will readily appreciate that other circuitry may be used.

While the foregoing example is directed to an analog signaling scheme, those skilled in the art would readily be able to implement control concepts of the present disclosure in a digital signaling scheme where a camera body communicates various state and control information internally and/or externally using digitally encoded information. In addition, it is noted that while the foregoing example is directed to a controller located externally relative to a camera body, as mentioned above a controller of the same, like or other control functionality can be built into a camera body. A potential advantage of building a controller implementing broad concepts of the present disclosure into a camera body is that a greater variety of camera body signals would likely be available, since typically only a subset of the signals generated by a camera body are normally available externally to a camera body through various ports on the camera body.

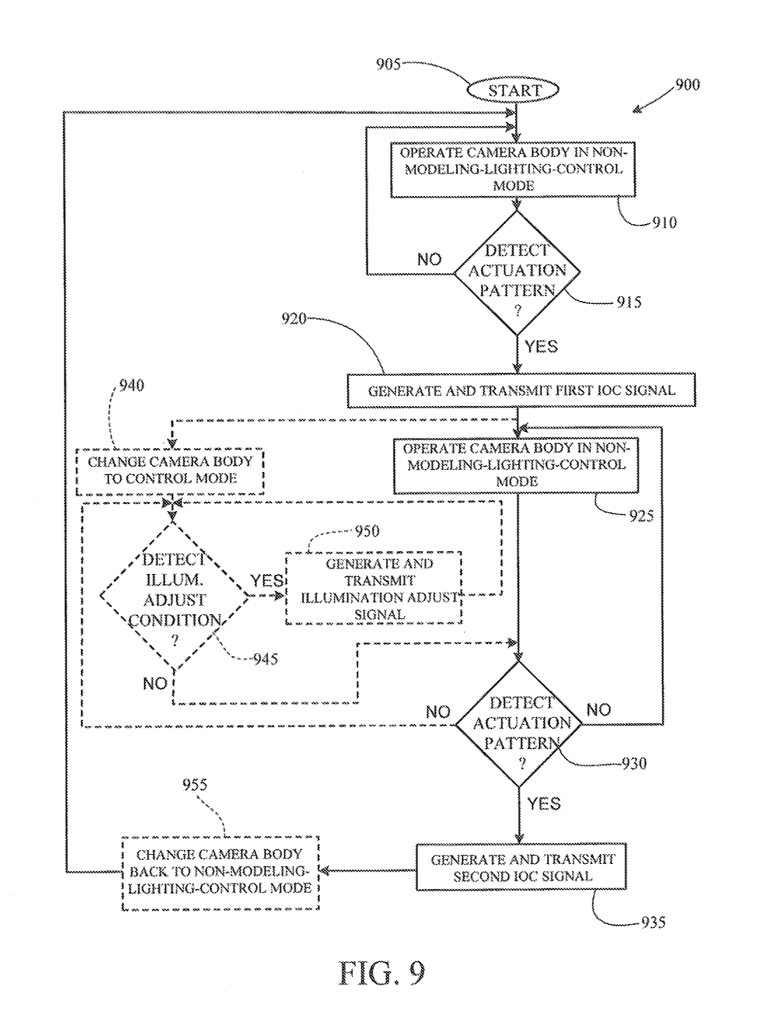

For example and referring to FIG. 9 and also to FIG. 2, FIG. 9 illustrates a method 900 of using one or more camera body controls, such as shutter-release control (button), menu-on/off button, scroll wheel/selector button (a/k/a “click wheel”), camera body backlighting control, etc., to control operation of modeling lighting, such as the modeling lighting functionality of multifunctional lighting system 208 and/or modeling light 212 (FIG. 2). Relative to example camera body 204, that camera body includes shutter-release button 224, a menu-on/off switch 284, a click wheel 288 and backlighting control button 236. As mentioned above, shutter-release button 224 of camera body 204 implements the common partial (half) press feature that activates a partial-press switch (not shown) that results in a partial-press signal within the camera body that can cause the camera body to initiate a variety of functionality, such as wakeup, autofocusing, through-the-lens metering, etc., as will be understood by those skilled in the art. Menu-off/on switch 284 in this example is a button-type switch that results in a menu on/off signal within camera body 204. The scroll wheel portion of click wheel 288 is a control commonly used on contemporary digital single lens reflex cameras (often in combination with another control) that allows a photographer to efficiently scroll through a list of camera body settings. As one example, a scroll wheel is sometimes used in flash compensation mode to allow a photographer to scroll among flash compensation values. Often (as here), though not always, a scroll wheel is incorporated into a button-type switch that allows a photographer to make a selection by pressing on the control wheel. When a user actuates the scroll wheel of click wheel 288, a scroll wheel signal is generated internally to camera body 204. Similarly, when a user actuates the selector button of click wheel 288, the selector button signal is generated internally to camera body 204. The microprocessor (not shown) of camera body 204 uses these signals to control the appropriate camera body functionality.

Method 900, however, can implement any one or more of these and/or other camera body signals to allow a user to control operation of modeling lighting. Method 900 provides such control by interpreting one or more patterns of user-actuation of one or more camera body controls to be instructions for controlling operation of modeling lighting. As used herein and in the appended claims, the term “pattern” is intended to cover multiple actuations of one or more controls, such as three rapid partial presses of a shutter-release button, as well as the simultaneous and/or sequential actuation of two or more controls, such as actuating backlighting control button 236 while holding down menu on/off switch 284, among many other possibilities. As will be readily appreciated by those skilled in the art, there are so many possible scenarios of such patterns that it is not practical, or even possible, to list every one. That said, those skilled in the art will understand that whatever pattern(s) is/are selected for implementation, an important overarching concept is that each pattern be so as to minimize the likelihood of the pattern or any portion thereof inadvertently changing a camera body setting not relating to the control of modeling lighting.

Method 900 begins at step 905, for example, when the camera body (here, camera body 204) is powered on. At step 910, camera body 204 operates as it normally would upon powering up from an off state. At step 915, a modeling lighting controller monitors control signaling occurring within camera body 204 to determine whether a preset pattern of control actuation has occurred. As mentioned above, a preset pattern can be any of a variety of sequential actuation of any one or more camera body controls or simultaneous actuation of two or more camera body controls, or a combination thereof. For the sake of illustration, a rapid triple partial pressing of shutter-release button 224 (e.g., a user partially presses the shutter-release button three times in uninterrupted sequence with about one second) is used as the preset actuation pattern for toggling a modeling lighting control mode on and off. In other words, when step 915 detects the rapid triple partial press every odd-numbered time following startup at step 905, i.e., every 1^{st}, 3^{rd}, 5^{th}, 7^{th}, etc. time after startup, the modeling lighting controller enters the modeling lighting control mode. When the modeling lighting controller enters the modeling lighting control mode, it generates and transmits a first IOC signal to one or more modeling lighting devices, such as multifunctional lighting system 208 and/or modeling lighting device 212 of FIG. 2.

Depending on the robustness of the wireless control scheme of each modeling lighting device so controlled, in a manner similar to method 500 of FIG. 5 described above the transmitting of the first IOC signal may or may not be accompanied by an illumination output level that the modeling lighting device is to be changed to upon receiving the first IOC signal. In one example, this “change power level to” value may be input into the modeling lighting controller in a manner similar to the manner illustrated in FIG. 4 relative to controller 216 of FIG. 2. In another example, the modeling lighting controller implementing the method of FIG. 9 may simply send, effectively, a toggle command to one or more modeling lighting devices that causes each such device to toggle from one illumination output level to another, such as from off to on, or vice versa.

It is noted that a modeling lighting controller that implements method 900 may be the same as or similar to controller 216 of FIGS. 2 and 3. Indeed, external controller 216 itself could be configured to perform method 900 for a number of camera bodies. Although most, if not all, currently available camera bodies do not make half-press switch signals available through a hotshoe (here, hotshoe 220), many camera bodies make such signaling available via one or more other external ports on the camera body, for example, a USB port or a proprietary port. Often this is done to allow a camera body to be remotely controlled. Consequently, an external controller enabled to performed method 900 could include a connection, such as a wired connection (e.g., wired connection 290 of FIG. 2), between a camera body port having access to partial-press signaling and itself (e.g., proprietary port 292). The circuitry aboard such a controller, for example, camera body signal interface 308 and microprocessor 300, could be configured to recognize the preset pattern, such as the rapid triple partial-press mentioned above. In alternative embodiments, like the alternative embodiments mentioned above relative to controller 216 vis-à-vis FIG. 3, a modeling light controller that implements method 900 or similar method may be located substantially entirely internally to the camera body. For example, the microprocessor(s) and other circuitry and software (e.g., firmware) already present with a particular camera body for providing non-modeling lighting control functionality, can be adapted to provide the functionality embodied in method 900. Those skilled in the art will readily understand how to implement such a camera-body based scheme.

If the modeling lighting controller does not detect a preset camera body control actuation pattern at step 915, method 900 simply loops back to step 910 and continues with non-modeling-lighting-control operation. However, if the modeling lighting controller has detected a preset user control pattern at step 915 and transmitted the first IOC signal at step 920, method 900 may in one embodiment proceed to step 925 wherein camera body 204 resumes its normal non-modeling-lighting-control operation. If method 900 proceeds to step 925, it may then proceed to step 930 at which the modeling lighting controller monitors the camera body control signal lines to determine whether another preset user control actuation pattern has occurred. In this example, the pattern is another rapid triple partial pressing of shutter-release button 224, but in other embodiments, the pattern at issue may be different from the pattern at step 915. If the modeling lighting controller does not detect the pattern at issue at step 930, method 900 loops back to step 925 and camera body 204 continues in normal non-modeling-lighting-control operation, while the modeling lighting changed in response to step 920 remain so changed.

However, if the modeling lighting controller detects the preset actuation pattern at step 930, method 900 proceeds to step 935 at which the controller generates and transmits a second IOC signal, along with any change-to-level setting. In one example, wherein the first IOC signal turned-on a particular modeling lighting device, the second IOC signal turns off that device. Method 900 then loops back to step 910 and camera body 204 operates in its normal non-modeling-lighting-control mode while the modeling lighting remains in whatever state it just turned to in response to step 935.

In the foregoing steps of method 900 just described, camera body 204 could be considered to not have changed modes of operation at any time, but rather may be considered to simply send appropriate first and second IOC signals in response to the controller detecting the corresponding preset camera body control actuation pattern(s). In an alternative embodiment illustrated by the portion of method 900 in dashed lines, camera body 204 may be considered to change modes, since the functionality of one of the camera body controls (here, click wheel 288) changes to suit a particular purpose after the modeling lighting controller has transmitted the first IOC signal at step 920. In one example, the first IOC signal transmitted at step 920 causes modeling lighting to turn on from an off state. Instead of continuing “normal” operation of camera body 204 at step 925, method 900 proceeds to step 940 at which the camera body may be said to change its mode of operation to a “modeling lighting control mode.”

In one example utilizing click wheel 288 on camera body 204, this change of mode means that the camera body changes the functionality of the scroll wheel from any of its conventional uses, such as flash-compensation adjustment, to a control for adjusting the illumination output of modeling lighting essentially in real time while the camera body is in the modeling lighting control mode. As those skilled in the art will appreciate, utilizing the scroll wheel functionality of click wheel 288 as a modeling lighting illumination output adjustment control can be readily accomplished in camera body control software (firmware) in conjunction with an appropriately configured modeling lighting controller that utilizes the variable signal resulting from a user turning the scroll wheel. For example, as a user turns the scroll wheel of click wheel 288 in one direction, the modeling lighting controller could interpret this action as requiring it to transmit to modeling lighting a series of increasing illumination power output levels in a coordinated manner with the turning of the scroll wheel. Conversely, when the user turns the scroll wheel of click wheel 288 in the opposite direction, the modeling lighting controller would interpret this action as requiring it to transmit to modeling lighting a series of decreasing illumination power output levels in a coordinated manner with the turning of the scroll wheel.

This adjustment via click wheel corresponds to step 945 of method 900 at which the modeling lighting controller detects whether or not an illumination adjustment condition (in the foregoing example, the turning of the scroll wheel portion of click wheel 288) is occurring. If so, method 900 proceeds to step 950 at which the modeling lighting controller generates and transmits to the modeling lighting one or more illumination output adjustment signals. In the context of generator pack 256 of multifunction light system 208 of FIG. 2, which has a robust set of operating instructions, such an adjustment signal may include a series of transmitted illumination power levels corresponding to the user's movement of the wheel portion of click wheel 288. If at step 945 the modeling lighting controller does not detect an illumination adjustment condition, method 900 proceeds to step 930 where the controller determines whether or not a preset actuator pattern is detected. If not, camera body 204 remains in modeling lighting control mode and method 900 loops back to step 945. However, if the modeling lighting controller detects the preset camera body control actuation pattern that causes the modeling lighting controller to end the modeling lighting control mode, method 900 proceeds to step 935 and then to step 955. At step 935, the modeling lighting controller generates and transmits a second IOC signal that, for example, turns the modeling lighting off. At step 955, the modeling lighting controller changes camera body 204 from the modeling lighting control mode back to the non-modeling-lighting-control mode. Immediately following step 955, the scroll wheel of click wheel 288 resumes the functionality it had prior to camera body 204 entering modeling lighting control mode.

To briefly summarize the usefulness of the full functionality of method 900, assume modeling lighting is desired to be on only for a few seconds so as to allow a photographer to check for desired and undesired effects that an image-acquisition strobe flash will have in a captured image. Assume further that the photographer is standing at a camera (which is enabled to perform the steps of method 900, such as with an internal modeling lighting controller and wireless transmitter), the modeling lighting is presently turned off and the photographer does not know what the illumination output level of the modeling lighting will be when it is turned on. Instead of leaving the camera to check the illumination output setting(s) of the modeling lighting and turn the modeling lighting on, while the photographer is still standing at the camera, and even while looking through the camera's viewfinder, the photographer can turn the modeling lighting on, make any needed illumination output adjustments and then turn the modeling lighting off using one or two finger and controls that the photographer is already intimately familiar with.

As a specific example, and assuming the camera has a combination click wheel and the modeling lighting controller is responsive to signals therefrom as follows, the photographer could turn the modeling lighting on by rapidly double pressing the click wheel (steps 910, 915, 920). This would also put the camera into modeling lighting control mode (step 940). Then, while in this mode, the photographer could adjust the light output of the modeling lighting by turning the click wheel (steps 945, 950) and then make the assessment of the lighting effect(s). Once the photographer has finished the lighting assessment, the photographer may then turn the modeling light off and change the camera back to its “normal” operating mode by again rapidly double pressing the click wheel (steps 930, 935, 955). The photographer could then move on to image capturing.

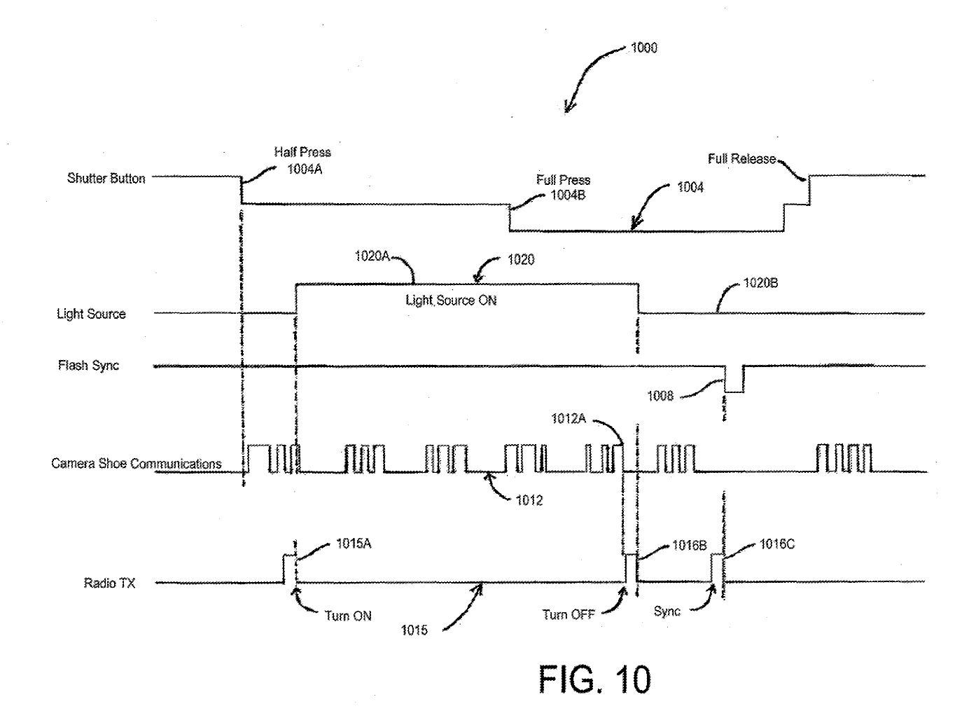

To illustrate the many implementations of features and systems disclosed herein, the following additional examples are provided. Referring to FIG. 10, and also to FIG. 2, FIG. 10 is a timing diagram 1000 that illustrates using camera body controls and signals to provide pupil-dilation functionality. It has been found that in some styles of photography, especially with human models, that it is desirable to photograph the model when the pupils of the model's eyes are dilated so as to create a sense of attraction or interest of the model to the target audience. This pupil-dilation effect can be created by subjecting the model to relatively bright light prior to image-capture so as to cause the model's pupils to constrict and then, just prior to image-capture, remove the bright light so that the pupils dilate during image-capture. In a sense, this is essentially opposite of what occurs during a conventional red-eye-reduction process in which a bright light from a pre-flash is fired just before image acquisition so that the pupils of a subject's eyes constrict during image-capture in order to reduce the amount of reflection of the image-acquisition flash off of the retinas of the subject's eyes that causes the well-known red-eye phenomenon in head-on flash photography.

As described below, this example utilizes the half-press and full-press functionality of a camera body shutter-release button, such as shutter-release button 224 of FIG. 2, to control one or more modeling lighting devices, such as devices 212, 244 of FIG. 2, as well as a conventional camera-body red-eye reduction pre-flash signal to implement the pupil-dilation functionality. That said, those skilled in the art will appreciate that other examples can use other camera-body signals to implement this pupil-dilation functionality. Referring again to FIG. 10, timing diagram 1000 contains: a shutter-release signal 1004 that indicates the state of the shutter-release button; a shutter sync signal 1008 that starts the opening of the camera body's shutter; a status communication signal 1012 that communicates statuses of various functionality/features of the camera body to various parts of the camera body, for example a hotshoe; a transmitted signal 1016 that is provided by the camera body or device external to the camera body, such as controller 216 of FIG. 2, and a lighting device status curve 1020 that indicates the status of the lighting device(s) being controlled to provide pupil-dilation functionality.

In this example, the pupil-dilation functionality is enabled by a controller, such as controller 216 of FIG. 2, that is in communication with the hotshoe of the camera body, such as hotshoe 220 of camera body 204. Controller 216 utilizes camera body signals available on hotshoe 220, specifically, a half-press, or wake, signal 1004A (FIG. 10), a full-press, or shutter-trigger, signal 1004B, a red-eye reduction signal 1012A and sync signal 1008 to generate and transmit various control signals, such as lighting device turn-on signal 1016A, lighting device turn-off signal 1016B and transmitted sync signal 1016C.

The pupil dilation functionality in this example is initiated by a half-press of shutter-release button 224, which results in a wake signal 1004A being available on hotshoe 220. Controller 216 senses wake signal 1004 and, in turn, transmits lighting device turn-on signal 1016A to the lighting devices at issue, for example, lighting devices 212, 244, which causes the lighting devices to turn on, as indicated by the on-portion 1020A of lighting device status curve 1020. When the photographer (not shown) is ready to capture an image, he/she performs a full-press on shutter-release button 224, which causes camera body 204 to generate shutter-trigger signal 1004B. Shutter-trigger signal 1004B, in turn, causes camera body 204 to generate, at certain times after the trigger signal, other signals, such as red-eye reduction signal 1012A and sync signal 1008. As mentioned above, pupil-dilation functionality works in a manner essentially opposite of red-eye-reduction functionality. Whereas red-eye reduction operates to initiate a pre-flash a predetermined time-period prior to image-capture, pupil dilation operates to turn off bright light a predetermined time-period prior to image-capture. The present example takes advantage of red-eye-reduction signal 1012A to turn off (or down) lighting devices 212, 244 rather than initiate a pre-flash.

Consequently, in response to detecting red-eye reduction signal 1012A at hotshoe 220, controller 216 generates and transmits to lighting devices 212, 244 turn-off signal 1016B that causes the lighting devices to turn off or otherwise reduce their illumination output to a level that allows a model's pupils to dilate. This is illustrated by off-portion 1020B of lighting device status curve 1020. At some point shortly after camera body 204 has generated red-eye-reduction signal 1012A, the camera body generates shutter-sync signal 1008, which controller 216 detects at hotshoe 220 and responds to by generating and transmitting transmitted sync signal 1016B. In conjunction with shutter-sync signal 1008, camera body 204 captures an image of the model at a time in which the model's pupils are sufficiently dilated to produce the desired dilated-pupil effect described above. As those skilled in the art will readily appreciate, transmitted sync signal 1016C generated by controller 216 can, for example, be used by lighting device 244 to trigger flash source 248 and/or by any other image-acquisition lighting source.

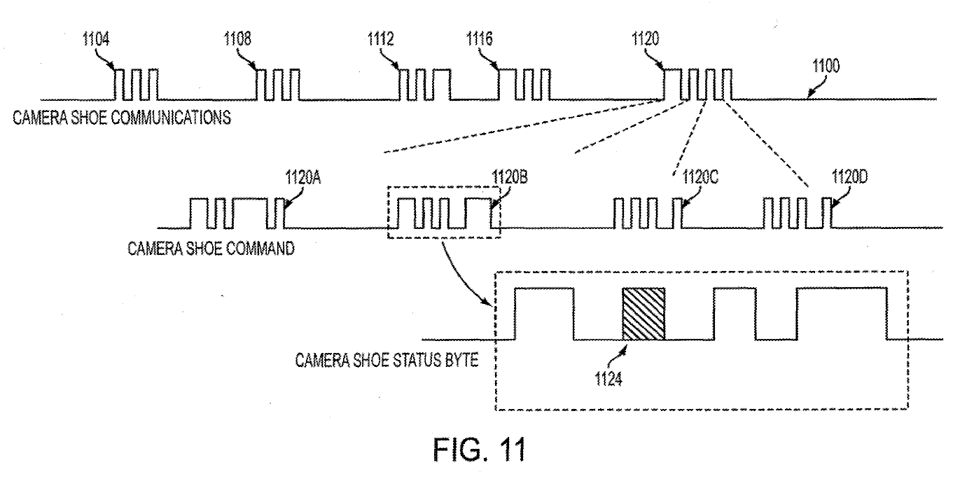

As mentioned above, modeling lighting functionality disclosed herein can be implemented regardless of whether the camera body signal(s) utilized is/are analog signals or digital signals. The examples of FIGS. 6-8, above, are directed to utilizing analog AF assist and backlighting control signals of a corresponding camera body that generates such signals to achieve the described exemplary lighting device control functionality. For the sake of completeness, FIG. 11 illustrates a digital camera-body-status communication signal 1100 that generally includes digital equivalents to the AF assist and backlighting signals discussed above. In this example, when the camera body is awake the camera body continually broadcasts camera-body/flash status and settings information via communication signal 1100 in the form of digital data bursts, here 1104, 1108, 1112, 1116, 1120 that each contain, for example, 12 to 24 bytes of status information, bits of which indicates statuses of various camera-body/flash status and settings. In this example, FIG. 11 shows four bytes 1120A-D of such 12 to 24 bytes of burst 1120, and one of these bytes, i.e., byte 1120B, contains a status bit 1124 of interest. In this example, status bit 1124 is a bit that indicates whether or not the backlight is on, with a high value (1) indicating on and a low value (0) indicating off. Byte 1120B or other byte of any one of the data bursts can also include a status bit indicating that an AF-assist request has been made. The same is true for many other camera-body signals, such as a red-eye-reduction signal, among others. When the camera-body signals being utilized for modeling lighting control functionality, the corresponding controller, for example, the digital counterpart to controller 216 of FIG. 2, can be configured to monitor communications signal 1100 for the bit(s) of interests, for example, using digital signal monitoring techniques known in the art. Once the controller detects the desired signal(s) it can implement the desired modeling lighting control functionality, for example, any one or more of the functionalities described herein.

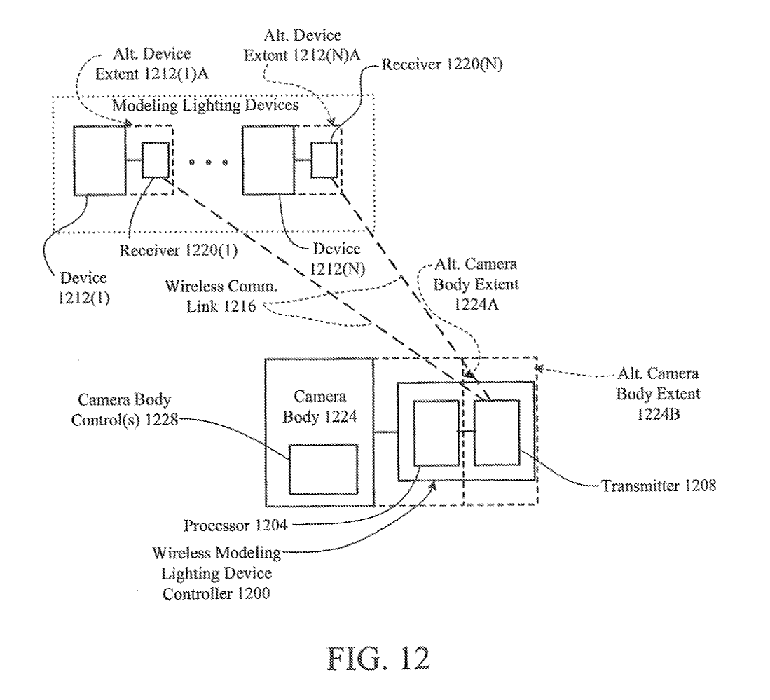

In the example photographic system 200 of FIG. 2, modeling lighting device controller 216 is a hotshoe-mountable wireless device shown mounted to hotshoe 220 of camera body 204 that communicates wirelessly with one or more modeling lighting devices, specifically devices 212, 244 in the case of FIG. 2. It is noted, however, that a modeling lighting device controller made in accordance with the present disclosure does not have to be completely external to a camera body. On the contrary, in alternative embodiments, one or more parts of such a controller can be located internal to the camera body. This is illustrated in FIG. 12 in the context of a wireless modeling lighting device controller 1200.

Referring now to FIG. 12, in this example controller 1200 includes a processor 1204 that generally executes the logic needed to provide modeling lighting control functionality, such as any of the functionalities described herein, and generating the appropriate IOC signal(s), and also a wireless transmitter 1208 for transmitting such IOC signal(s) to the appropriate modeling lighting device(s), such as any one or more of devices 1212(1) to 1212(N), via corresponding respective wireless communications links 1216 to corresponding respective receivers 1220(1) to 1220(N) at the modeling lighting device(s). It is noted that for clarity, FIG. 12 does not show any components of controller 1200 needed to support the operation of processor 1204 and transmitter 1208, such as, but not necessarily limited to, A/D and D/A converters, voltage comparators, memory, batteries, antenna(s), etc. It is also noted that transmitter 1208 could alternatively be a transceiver if two-way communication is needed to support modeling lighting control and/or other functionality of controller 1200. Transmitter 1208 and receiver(s) 1220(1) to 1220(N) can operate using any suitable wireless technology, such as RF, IR, visible light, etc., and those skilled in the art will readily understand how to implement any one of those technologies.

As mentioned, various parts of controller 1200 can be situated relative to a camera body 1224 in a variety of ways. For example, the solid lines depicting camera body 1224 illustrate a scenario in which controller is completely external to the camera body. An example of this is hotshoe-mounted controller 216 of FIG. 2. In such an embodiment, the external controller can receive the camera-body signal(s) necessary to provide modeling lighting control functionality via the hotshoe and/or other ports on the camera body. In other embodiments, however, one or both of processor 1204 and transmitter 1208 can be located inside camera body 1224. This is illustrated, respectively, by alternative camera body extents 1224A, 1224B. When processor 1204 is located internally to camera body 1224, it can receive the camera-body signal(s) needed to implement the desired modeling lighting device control functionality in any variety of ways, depending on the level of integration of the processor with the camera body. For example, processor 1204 can be integrated with camera body 1224 so as to receive the signals directed from the camera body processor(s) (not shown) and/or to receive the signal(s) by intercepting it/them on an electrical connection between the corresponding camera-body control(s) 1228 and the camera body processor(s). In another example, in a fully integrated camera body, processor 1204 can be the camera body processor(s). If transmitter 1208 is also internalized into camera body 1224 and it is an RF transmitter, care may need to be taken to design an appropriate antenna system (not shown) to ensure that the signals transmitted by the transmitter have an acceptable range. Like transmitter 1208 and camera body 1224, each receiver 1220(1) to 1220(N) can be located internally or externally to the corresponding respective modeling lighting devices 1212(1) to 1212(N), as indicated by the alternative device extents 1212(1)A to 1212(N)A.

While the foregoing explanations are directed to examples in which a single camera body is used to control one or more modeling lighting devices, the broad functionality disclosed herein can be used in multi-camera-body scenarios in which two or more camera bodies are being used by two or more corresponding photographers or are otherwise under separate control to control one or more modeling lighting devices. In such a scenario, the system could be set up so that one or more modeling lighting devices is set to change power state within several seconds of one of the camera bodies going into sleep mode, for example, by implementing any one of the delay-timer examples described above. In such a case, if one or more other cameras are still awake and being used, it would not be desired that the modeling lighting device(s) change power state. To avoid this unwanted result, the system, for example, controller 216 of FIG. 2, could be programmed to utilize any signal(s) from any one or more of the still-awake cameras to override an impending sleep-mode-induced delay timing-out to keep the modeling lighting device(s) from changing power state. For example, the controller could use a sync signal, a flash-exposure-change signal or a power-level-change signal, among others, from any remaining awake camera bodies to implement this override scheme.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1.-57. (canceled)

58. A method of controlling illumination output of a modeling lighting device located remote from a first camera body, the method comprising:
detecting at least one camera body signal from the first camera body;
generating a first illumination output change signal in response to said detecting of the at least one camera body signal, wherein the first illumination output change signal is configured to change the illumination output of the modeling lighting device to a first output;
transmitting the first illumination output change signal to the modeling lighting device so as to cause the modeling lighting device to operate at a first illumination output level;
starting a delay timer that delays transmitting of a second illumination output change signal configured to change the illumination output of the modeling lighting device from the first output to a second output different from the first output;
restarting the delay timer in response to detecting a wireless signal indicating that a second camera body is still awake; and
when the delay timer times out, transmitting the second illumination output change signal.

59. A method according to claim 58, wherein said restarting includes restarting the delay timer in response to detecting a flash-sync signal initiated by the second camera body.
